(19) United States
(12) Patent Application Publication
(10) Pub. No.: US 2002/0008387 A1
(43) Pub. Date: Jan. 24, 2002

(54) Exhaust system flanges

(76) Inventor: Kailash C. Vasudeva, Waterloo (CA)

Correspondence Address: BORDEN LADNER GERVAIS, LLP, 1000 - 60 QUEEN STREET, OTTAWA, ON, K1P 5Y7, CA

(21) Appl. No.: 09/758,311

(22) Filed: Jan. 12, 2001

Related U.S. Application Data
(60) Provisional application No. 60/176,043, filed on Jan. 14, 2000.
(60) Provisional application No. 60/194,765, filed on Apr. 3, 2000.

(51) Int. Cl. F16L 23/00

(52) U.S. Cl. 285/405

(57) ABSTRACT

Flanges formed by powder metallurgical methods are used for joining, for example, exhaust pipes, instead of manufacturing flanges by stamping, forging and/or machining. This offers a number of advantages, including the ability to produce flange shapes which cannot be obtained by stamping, forging and/or machining.

### REFERENCE TO RELATED APPLICATION

This is a formal application based on and claiming the benefit of U.S. provisional patent application No. 60/176,043, filed Jan. 14, 2000 and U.S. provisional patent application No. 60/194,765, filed Apr. 3, 2000.

### BACKGROUND OF THE INVENTION

1. Field of the Invention

This invention relates mainly to flanges used in exhaust systems of internal combustion engines, for example those commonly used in automobiles and trucks. In such systems, it is common to have stamped or forged and/or machined flanges which are welded to the ends of exhaust pipes which are to be joined to each other, with the flanges having flat mating surfaces which are bolted together with a gasket in between.

2. Description of the Prior Art

### SUMMARY OF THE INVENTION

It is an object of the invention to improve on the existing flanges used in exhaust systems and other welded or assembled flange joints.

In the invention, instead of manufacturing flanges by stamping, forging and/or machining, the flanges are formed by powder metallurgy, which offers a number of advantages, including the ability to achieve flange shapes which cannot be obtained by stamping.

This permits the flange configurations of the invention to be achieved. There are two flanges in the invention, one of the end of one pipe and one for the end of the other pipe. The flanges have complementary shapes, such that one flange, hereinafter referred to as the “inner flange”, nests partially within the other flange, hereinafter referred to as the “outer flange”.

In one embodiment of the invention, one flange, preferably but not necessarily the inner one, has integral mounting studs on opposing sides of the pipe, configured to extend through corresponding holes in the other flange. The studs are threaded to receive nuts which are tightened to pull the two flanges together for a secure connection.

Preferably, the proximal surfaces of the flanges, i.e. the surfaces of the flanges away from their distal mating surfaces, have reinforcement ribs, which permits the overall thickness and therefore the weight of the flanges to be reduced compared to conventional flanges.

As an alternative to reinforcement ribs and thin sections to reduce weight, the flanges could be of uniform thickness, with through holes formed in several locations to achieve the same weight reduction.

In a further embodiment of the invention, the flanges have extensions for attachment by press-fitting, spinning, resistance welding, crimp rolling etc. to the exhaust pipes. Thus, no welding is necessary, other than as a further reinforcement of the joint.

The nesting together of the flanges provides a better seal, in that there is no direct escape route for exhaust gases, thus reducing the need for expensive gaskets or perhaps eliminating the need for gaskets altogether. Also, larger diameter stud posts and matching holes with close tolerances become possible with powder metallurgy. This helps ensure a rigid joint.

Another advantage of the invention is that since the mounting studs may be integral to the flanges, the assembly joint will tend to remain intact even if the nuts become loose or dislodged, whereas in typical prior art flanges, the separate bolts will fall out, permitting the joint to shift. In the invention, the nesting eliminates lateral shifting of the joint, even if the nuts are loose or missing, making the joint much more mechanically secure. Of course, if both nuts are missing, the joint may come apart longitudinally, but at least it will not separate laterally.

Thus, in the invention, an exhaust flange assembly for joining ends of exhaust pipes, comprises an outer flange, having a sealing surface and a pipe attachment means arranged on a pipe attachment surface opposite to the sealing surface; and an inner flange, having a sealing surface and a pipe attachment means arranged on a pipe attachment surface opposite to the sealing surface. The flanges are made of powder metallurgically produced material.

In one embodiment of the invention, the outer flange has a cavity defined in the sealing surface and the sealing surface of the inner flange is shaped to be closely received by the cavity. Further, one of the flanges advantageously has integral mounting studs extending from the sealing surface of the flange, the studs configured to extend through corresponding holes in the other the flange, the studs being threaded to receive nuts whereby the flanges may be pulled together for a secure connection by tightening the nuts. Preferably, at least one of the flanges has an annular gasket recess arranged on the sealing surface of the flange. The pipe attachment surfaces of the flanges preferably have a plurality of reinforcement ribs. The flanges may further have at least one hole therethrough for weight reduction.

Preferably, the outer flange and the inner flange have bolt mounting holes arranged to receive threaded bolts onto which nuts are threadable, whereby the flanges may be pulled together for a secure connection by tightening the nuts.

Alternatively, the outer flange has a curved extension protruding in a direction opposite to the cavity, and the inner flange has a curved extension protruding in a direction opposite to the sealing surface of the inner flange, the extensions arranged to be fitted into the ends of exhaust pipes, thereby deforming the exhaust pipes to form a secure joint. Preferably, the extensions have a groove surrounded by an inner ridge and an outer ridge, arranged on an outer surface of the extension. Advantageously, at least one of the flanges has an annular gasket recess arranged on the sealing surface of the flange. Optionally, the pipe attachment surfaces of the flanges have a plurality of reinforcement ribs. The flanges may further have at least one hole therethrough for weight reduction.

Advantageously, the bolts have generally spherical portions facing the bolt thread, the spherical portions of the bolts arranged to cooperate with generally concave recesses arranged in the flanges around the mounting holes.

Preferably, at least one of the flanges has an annular gasket recess arranged on a sealing surface of the at least one flange.

The inner flange advantageously comprises a first substantially flat part and a second annular sealing part. The first part has a first recess and the second part has a second recess, the recesses having complimentary shapes so that the first recess fits in the second recess. Preferably, the first recess and the second recess have multiple steps.

Still a further embodiment of an exhaust flange assembly according to the invention comprises a straight flange cooperating with a curved flange, where an outer edge of the curved flange is bent away from a surface of the curved flange which contacts the straight flange, so that, when the straight flange is mounted to the curved flange by fasteners, the curved flange deflects towards the flat flange to form a flat sealing surface, thus enhancing the seal between the curved flange and the straight flange, the flanges being made of powder metallurgically produced material. Preferably, the straight flange and the curved flange have mounting holes and the fasteners comprise mounting bolts, for placing through the mounting holes, and mounting nuts to be tightened onto each the mounting bolt, for fastening the straight flange to the curved flange. Advantageously, the straight flange and the curved flange have gasket recesses, for accommodating gaskets. Preferably, the curved flange is substantially weakly bowl-shaped.

Preferably, the outer flange is made of one material and the inner flange is made of another material.

A preferred method of producing two-part exhaust flanges, comprises the steps of:

a) press-forming metal powder to shape a first substantially flat part of an inner flange;

b) press-forming metal powder to shape a second annular sealing part of the inner flange;

c) fitting the first part onto the second part; and

d) sintering the first part and the second part to thereby bond them together and form the inner flange.

Advantageously, the method further comprises the step of pre-sintering the first part and the second part after press-forming but before fitting the first part onto the second part.

Preferably, the materials used for making the flanges contain 0.75 to 1 weight percent of hexagonal boron nitride (BN), which enhances the corrosion resistance properties of the powder metallurgical materials used.

Further features will be described or will become apparent in the course of the detailed description which follows.

### BRIEF DESCRIPTION OF THE DRAWINGS

The invention will now be described in greater detail, with reference to the accompanying drawings of the preferred embodiment, in which:

FIG. 1 is an exploded side view showing the inner and outer flanges welded on ends of exhaust pipes to be joined;

FIG. 2 is a sectional side view corresponding to FIG. 1;

FIG. 3 is a side view showing the assembled exhaust pipes;

FIG. 4 is a proximal end view of the outer flange;

FIG. 5 is a side view of the outer flange;

FIG. 6 is a distal end view of the outer flange;

FIG. 7 is a distal end view of the inner flange;

FIG. 8 is a side view of the inner flange;

FIG. 9 is a proximal end view of the inner flange;

FIG. 10 is a sectional view of the inner flange at A-A on FIG. 9;

FIG. 11 is a top view of the inner flange;

FIG. 12 is a distal end view of an alternative embodiment of the outer flange;

FIG. 13 is a side view of the alternative embodiment of the outer flange;

FIG. 14 is a proximal end view of the alternative embodiment of the outer flange;

FIG. 15 is a proximal end view of the outer flange according to yet another embodiment;

FIG. 16 is a side view of the outer flange according to FIG. 15;

FIG. 17 is a distal end view of the outer flange of FIG. 15;

FIG. 18 is a proximal end view of the inner flange corresponding to and cooperating with the outer flange according to FIG. 15;

FIG. 19 is a side view of the inner flange according to FIG. 18;

FIG. 20 is a distal end view of the inner flange according to FIG. 18;

FIG. 21 is an exploded side view showing the inner and outer flanges, according to FIGS. 15 and 18, pushed on ends of exhaust pipes to be joined;

FIG. 22 is a sectional side view corresponding to FIG. 21; showing the assembled flange joint;

FIG. 23 is a side view showing the assembled exhaust pipes, for flanges according to FIGS. 15 and 18;

FIG. 23A is an exploded side view of still a further embodiment of a flange joint according to the invention;

FIG. 23B is an exploded side view of yet a further embodiment of a flange joint according to the invention;

FIG. 24 is an end view of a flange joint according to a further embodiment of the invention; showing a flange having reinforced areas;

FIG. 25 is a sectional side view of the flange of FIG. 24 along line C-C;

FIG. 26 is a side view of a flange joint according to a yet further embodiment of the invention; showing a flange having a curved half;

FIG. 27 is an exploded partially sectioned side view of a flange joint according to a further embodiment of the invention; showing a flange having a gasket;

FIG. 28 is an exploded partially sectioned side view of a flange joint according to still a further embodiment of the invention; showing a flange having a further embodiment of a gasket;

FIG. 29 is an assembled partially sectioned side view of the flange joint of FIG. 28;

FIG. 30A is an exploded side view of a flange joint according to a further embodiment of the invention, similar to the embodiment of FIG. 28; having the composite gasket bonded onto the inner flange;

FIG. 30B is an assembled sectioned side view of the flange joint of FIG. 30A;

FIG. 31A is an end view of a flange joint according to a further embodiment of the invention, showing a gasket recess;

FIG. 31B is a sectioned side view of the flange joint of FIG. 31A;

FIG. 32A is an end view of a flange joint according to still a further embodiment of the invention, showing a further variation of a gasket recess;

FIG. 32B is a sectioned side view of the flange joint of FIG. 32A;

FIG. 33 is a sectioned side view of a further embodiment of a flange joint of the invention, similar to the flange of FIG. 30B with the addition of a gasket recess on the composite gasket;

FIG. 34 is a sectioned side view of a still further embodiment of a flange joint of the invention, similar to the flange of FIG. 30B with the addition of a gasket recess on the composite gasket, which is an integral part of the inner flange;

FIG. 35 is a sectional side view of yet a further embodiment of a flange joint of the invention, showing a pair of flanges where the inner flange has a sealing extension for cooperation with a sealing recess arranged in the outer flange;

FIG. 36 is a partially sectioned side view of another embodiment of a flange joint of the invention, showing a pair of flanges where the inner flange has a gasket holding ridge for cooperation with a gasket holding recess arranged in the outer flange and a gasket;

FIG. 37 is a sectioned side view of the gasket of FIG. 36;

FIG. 38 is a front view of the gasket of FIG. 37;

FIG. 39A is a front view of a further embodiment of an outer flange according to the invention, having a conical rib on its sealing side;

FIG. 39B is a sectioned side view of the outer flange as seen from line F-F of FIG. 39A;

FIG. 40A is a front view of a further embodiment of an inner flange according to the invention, having a conical recess on its sealing side;

FIG. 40B is a sectioned side view of the inner flange as seen from line G-G of FIG. 40A;

FIG. 41 is a sectioned side view of another embodiment of a flange joint of the invention, showing the outer flange of FIG. 39A and the inner flange of FIG. 40A;

FIG. 42 is a side view of the embodiment of a flange joint of FIG. 41, showing the outer flange of FIG. 39A and the inner flange of FIG. 40A joined to respective pipes and the connecting bolts used to clamp the flange joint together;

FIG. 43A is a front view of yet a further embodiment of an outer flange according to the invention, having a recess for cooperating with a further part of the flange and two bolt mounting holes;

FIG. 43B is a sectioned side view of the outer flange according to FIG. 43A;

FIG. 44A is a front view of still a further embodiment of an outer flange according to the invention, having a stepped recess for cooperating with a further part of the flange and three bolt mounting holes;

FIG. 44B is a sectioned side view of the outer flange according to FIG. 44A;

FIG. 45 is a sectioned side view of a further embodiment of an outer and an inner flange according to the invention, where the outer flange is manufactured in two parts;

FIG. 46 is a sectioned side view of the outer flange according to FIG. 45, after assembly;

FIG. 47 is a sectioned side view of another embodiment of a flange joint of the invention, similar to the embodiment shown in FIGS. 41 and 42, but having an integral stand-off on the inner flange;

FIG. 48A is a sectioned side view of an outer flange according a further embodiment of the invention, where the flange is manufactured in two parts; and

FIG. 48B is a sectioned side view of the outer flange according to FIG. 48A after assembly.

### DETAILED DESCRIPTION

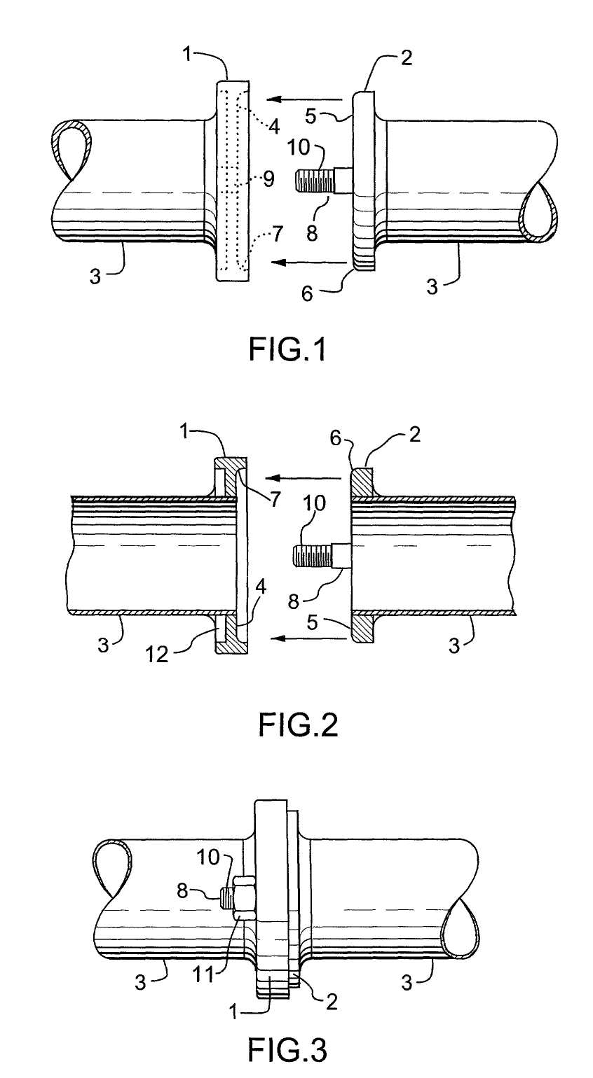

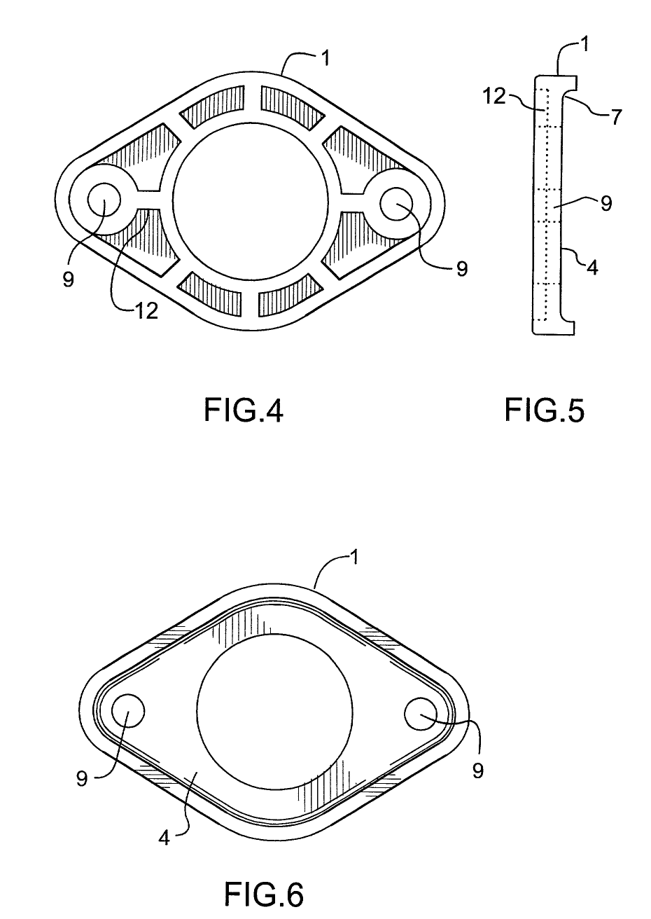

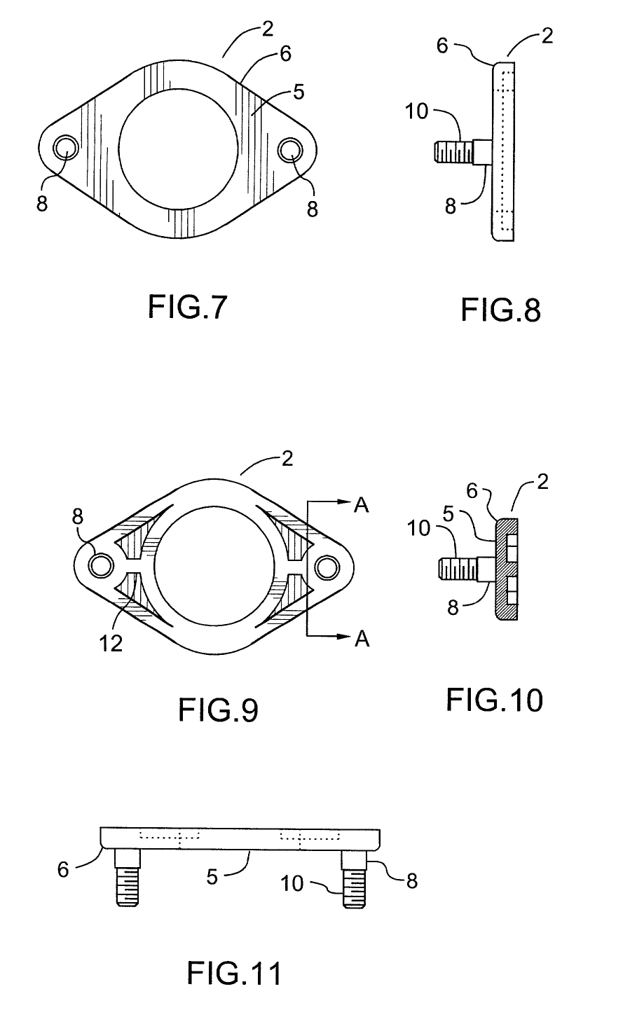

FIG. 1 shows an exhaust flange assembly, having two flanges 1 and 2 made of powdered metal welded to ends of exhaust pipes 3 to be joined. One flange, namely the “outer” flange 1, has a cavity 4 defined in its distal surface. The other flange, i.e. the “inner” flange 2, has a distal surface 5 with a shape complementing the shape of the cavity. Preferably, that shape involves a generally flat surface 5, with a rounded edge 6 to match a rounded inner edge 7 of the cavity 4 and thereby provide a sealing seat. In view of this rounding, there is no direct escape path for exhaust, which reduces or eliminates the need for a gasket. If a gasket is still needed, it may be that it could be a less expensive gasket in view of the reduced sealing needs.

Other edge shapes are certainly possible. For example, there could be a sharp edge, a radius, chamfer or domed seal, or combinations thereof.

One of the flanges, for example the inner flange 2, has integral mounting studs 8 on opposing sides, configured to extend through corresponding holes 9 in the other flange, i.e. the outer flange 1. After production of the flange by a typical powder metallurgy process, the studs are tapped to provide threads 10. Preferably, the studs are also provided with bolstered heads, to provide extra strength. Nuts 11 are installed to pull the flanges together for a secure connection by tightening the nuts.

Preferably, the proximal surfaces of the flanges, i.e. the surfaces of the flanges away from their distal mating surfaces, have reinforcement ribs 12, which permits the overall thickness and thus weight of the flanges to be reduced compared to conventional flanges.

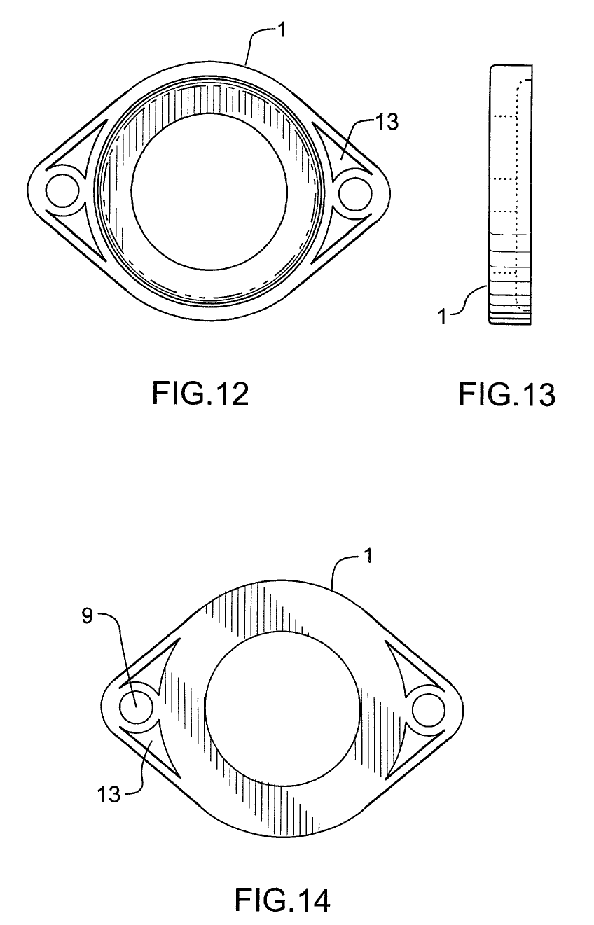

FIGS. 12-14 show an example of the above-mentioned alternative to reinforcement ribs and thin sections to reduce weight, in which the flanges are of uniform thickness, with through holes 13 formed in several locations to achieve the same weight reduction. Only the outer flange is shown, but preferably the inner flange would have corresponding aligned holes as well.

The invention provides a number of advantages, which include that the integral mounting studs avoid the need for separate studs, that the use of powdered metal permits reduced thickness and weight by permitting the use of reinforcing ribs, that the sealing configuration avoids a direct escape path for exhaust gases, thereby potentially reducing the need for gaskets and potentially reducing emissions.

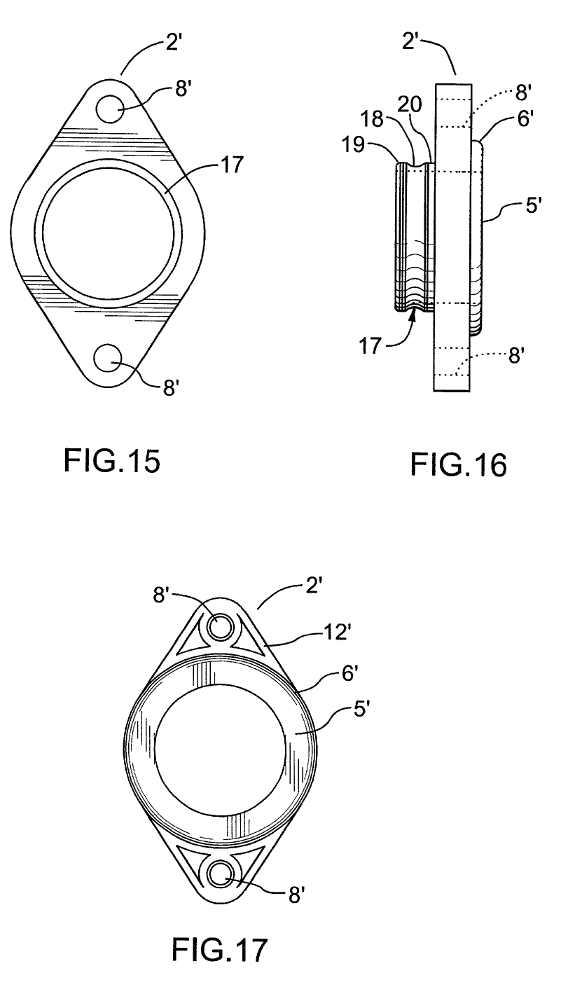

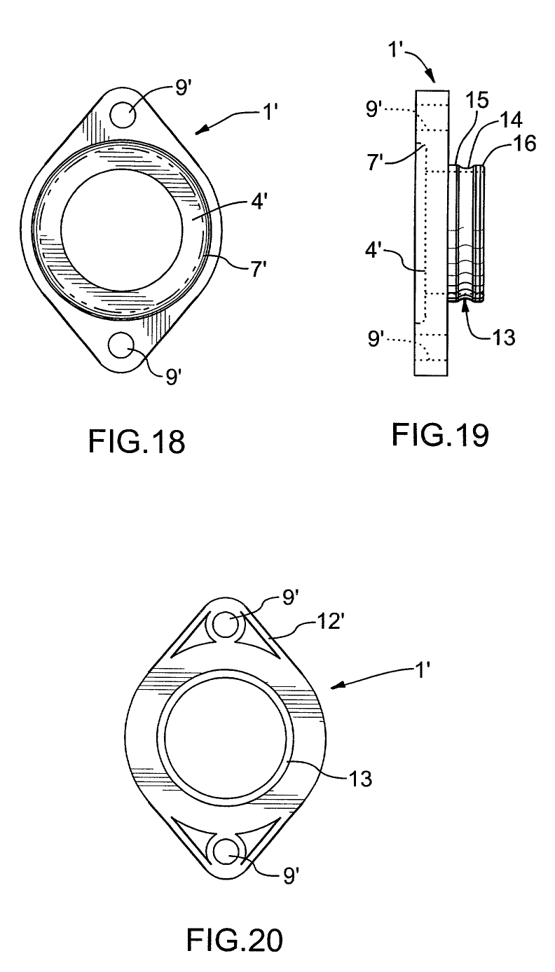

FIGS. 15 to 17 show a further embodiment of an “inner” flange 2′, made of powdered metal and attached by press-fitting, spinning, resistance welding, crimp rolling etc. to ends of exhaust pipes 3′ to be joined. In FIGS. 18 to 20, an “outer” flange 1′ is shown, which is cooperating with the “inner” flange of the embodiment according to FIGS. 15 to 17. The “outer” flange has a cavity 4′, defined in its distal surface. The “inner” flange 2′ has a distal surface 5′ with a shape complementing the shape of the cavity 4′. Preferably, the distal shape 5′ involves a generally flat surface, with a rounded edge 6′, to match a rounded inner edge 7′ of the cavity 4′ and thereby provide a sealing seat. In view of this rounding, there is no direct escape path for exhaust, which reduces or eliminates the need for a gasket. If a gasket is still needed, it may be that it could be a less expensive gasket in view of the reduced sealing needs.

Other edge shapes are certainly possible. For example, there could be a sharp edge, a radius, chamfer or domed seal, or combinations thereof.

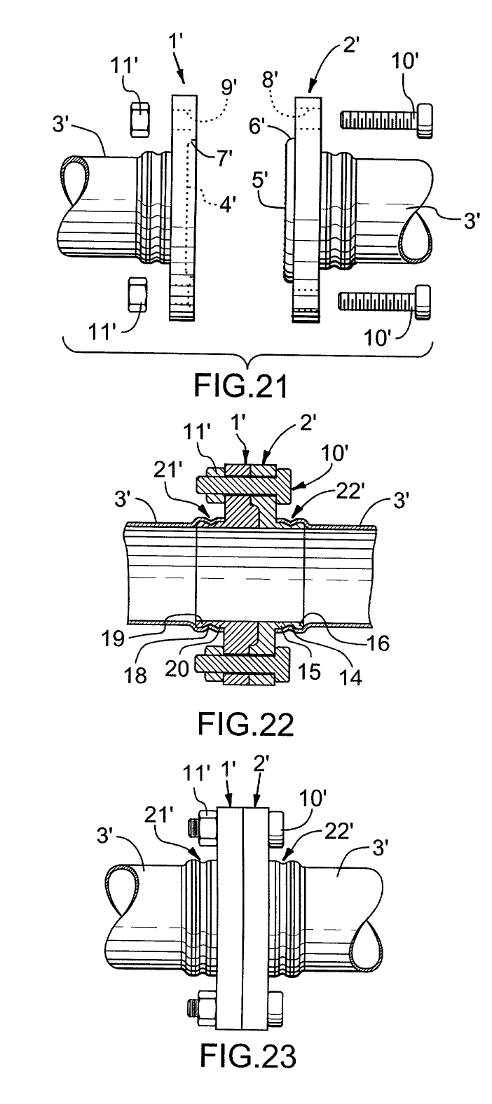

The “inner” flange 2′ further has an extension 17 arranged on the side of the flange opposite the distal shape 5′. The extension has a co-axial hole, corresponding to the hole in the flange, through which exhaust gases are flowing when the flange combination is in use. The extension has a substantially smooth inner surface and a grooved outer surface, preferably having a groove 18 surrounded by an inner ridge 20 and an outer ridge 19. The outer diameter of the extension is larger than the inner diameter of the exhaust pipe 3′. When the exhaust pipe is attached by press-fitting, spinning, resistance welding, crimp rolling etc. onto the flange 2′, the exhaust pipe expands and generally forms itself corresponding to the extensions outer profile, i.e. the groove 18, inner ridge 20 and outer ridge 19 (see FIGS. 21 to 23). In this way, the exhaust pipe is held securely to the flange. The extension may be tapered, having a larger outer diameter at a distal end of the extension as seen from the flange. In this case, the groove 18 is optional. Pressing the exhaust pipe onto the extension may be performed using a lubricant or inductively heating the pipe prior to installation. The grooves 18 may have a variety of profile shapes, to accommodate fitting of the pipes either by induction heating or resistance welding. The groove shape is thus determined by the assembly process or method.

The “outer” flange 1′ further has an extension 13 arranged on the side of the flange opposite the cavity 4′. The extension has a co-axial hole, corresponding to the hole in the flange, through which exhaust gases are flowing when the flange combination is in use. The extension has a substantially smooth inner surface and a grooved outer surface, preferably having a groove 14 surrounded by an inner ridge 15 and an outer ridge 16. The outer diameter of the extension is larger than the inner diameter of the exhaust pipe 3′. When the exhaust pipe is attached by press-fitting, spinning, resistance welding, crimp rolling etc. onto the flange 1′, the exhaust pipe expands and generally forms itself corresponding to the extensions outer profile, i.e. the groove 14, inner ridge 15 and outer ridge 16 (see FIGS. 21 to 23). In this way, the exhaust pipe is held securely to the flange. The extension may be tapered, having a larger outer diameter at a distal end of the extension as seen from the flange. In this case, the groove 14 is optional. Pressing the exhaust pipe onto the extension may be performed using a lubricant or inductively heating the pipe prior to installation. The grooves 14 may have a variety of profile shapes, to accommodate fitting of the pipes either by induction heating or resistance welding. The groove shape is thus determined by the assembly process or method.

The “inner” flange 2″ is preferably made of powdered metal and attached by press-fitting, spinning, resistance welding, crimp rolling etc. to ends of the exhaust pipes 3′ to be joined, forming a joint 22″. The “outer” flange 1″ is also preferably made of powdered metal and attached by press-fitting, spinning, resistance welding, crimp rolling etc. to ends of the exhaust pipes 3′ to be joined, forming a joint 21″.

The flanges have mounting holes 8′, 9′, respectively, for mounting a bolt 10′ and nut 11′. Alternatively, one flange has integral mounting studs on opposing sides, configured to extend through corresponding holes in the other flange, as described in conjunction with the previous embodiment. The nuts 11′ are installed to pull the flanges together for a secure connection by tightening the nuts.

Preferably, the proximal surfaces of the flanges, i.e. the surfaces of the flanges away from their distal mating surfaces, have reinforcement ribs 12′, which permits the overall thickness and thus weight of the flanges to be reduced compared to conventional flanges.

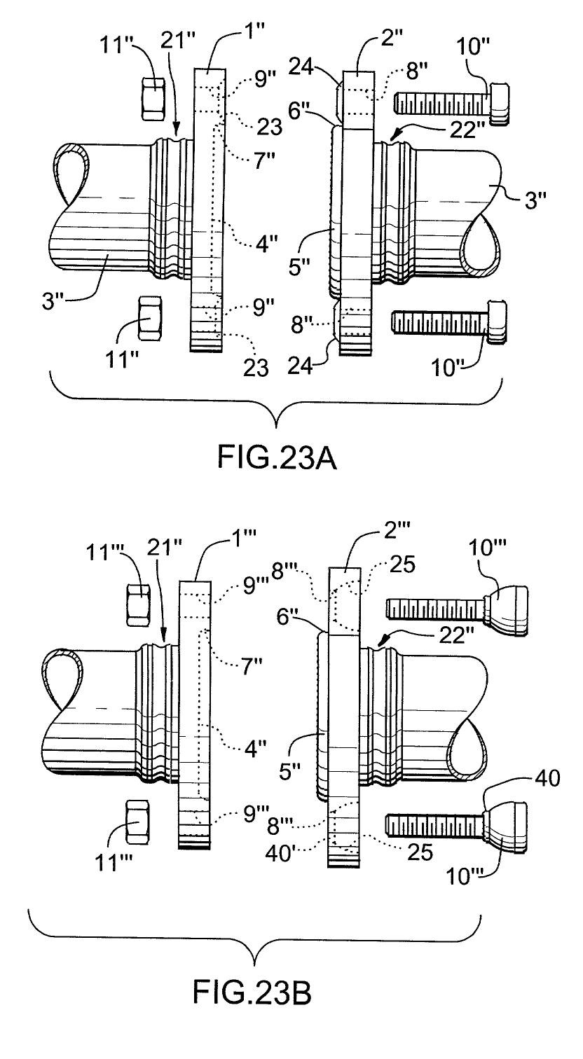

FIG. 21 shows the “outer” flange 1′ and the “inner” flange 2′ attached by press-fitting, spinning, resistance welding, crimp rolling etc. onto exhaust pipes 3′ and ready for having bolts 10′ inserted into holes 8′ and 9′ and nuts 11′ threaded onto the bolts, to tighten the flange joint. A tightened flange joint is shown in FIGS. 22 and 23.

FIG. 23A shows an “outer” flange 1″ and an “inner” flange 2″ pressed onto exhaust pipes 3′ and ready for having bolts 10″ inserted into holes 8″ and 9″, respectively, and nuts 11″ threaded onto the bolts, to tighten the flange joint. The “inner” flange 2″ is preferably made of powdered metal and press-fitted to ends of the exhaust pipes 3′ to be joined, forming a joint 22″. The “outer” flange 1″ is also preferably made of powdered metal and attached by press-fitting, spinning, resistance welding, crimp rolling etc. to ends of the exhaust pipes 3′ to be joined, forming a joint 21″. The “outer” flange 1″ cooperates with the “inner” flange. The “outer” flange has a cavity 4″, defined in its distal surface. The “inner” flange 2″ has a distal surface 5″ with a shape complementing the shape of the cavity 4″. Preferably, the distal shape 5″ involves a generally flat surface, with a rounded edge 6″, to match a rounded inner edge 7″ of the cavity 4″ and thereby provide a sealing seat. In view of this rounding, there is no direct escape path for exhaust, which reduces or eliminates the need for a gasket. If a gasket is still needed, it may be that it could be a less expensive gasket in view of the reduced sealing needs. Other edge shapes are certainly possible. For example, there could be a sharp edge, a radius, chamfer or domed seal, or combinations thereof. The “inner” flange 2″ has a projection 24 arranged on its surface, which faces the “outer” flange 1″. A recess 23, formed on a surface of the “outer” flange 1″, which faces the “inner” flange 2″, has a shape generally complementary to the projection 24, to facilitate the alignment of the two flanges with each other. Advantageously, the projections 24 and the recesses 23 are arranged concentrically to the holes 8″ and 9″, respectively.

FIG. 23B shows an alternative embodiment to the embodiment shown in FIG. 23A. The “outer” flange 1′″ is essentially the same as shown in FIG. 23B, except it does not have any recesses, the holes 9′″ are thus of one diameter. Instead, the “inner” flange 2′″ has holes 8′″ which have recesses 25 arranged on the side of the “inner” flange which faces away from the “outer” flange 1′″. The recesses 25 have generally concave surfaces, to cooperate with bolts 10′″, which have heads with generally spherical lower portions. Thus, the bolt is allowed to swivel in the holes 8′″ and 9′″, respectively, to facilitate alignment of the flanges. Advantageously, the “inner” flange 2′″ has an increased thickness, compared to the “outer” flange 1′″, to provide strength to compensate for the enlarged hole 8′″. Further, the bolts 10′″ advantageously have a substantially cylindrical extension 40 of the bolt head. The extension has a diameter which is larger than the diameter of the threaded portion of the bolt. A bolt recess 40′ arranged in the hole 8′″ of the “inner” flange 2′″ has a shape corresponding to the extension 40 of the bolt head, to securely hold the bolt once it has been tightened into the hole.

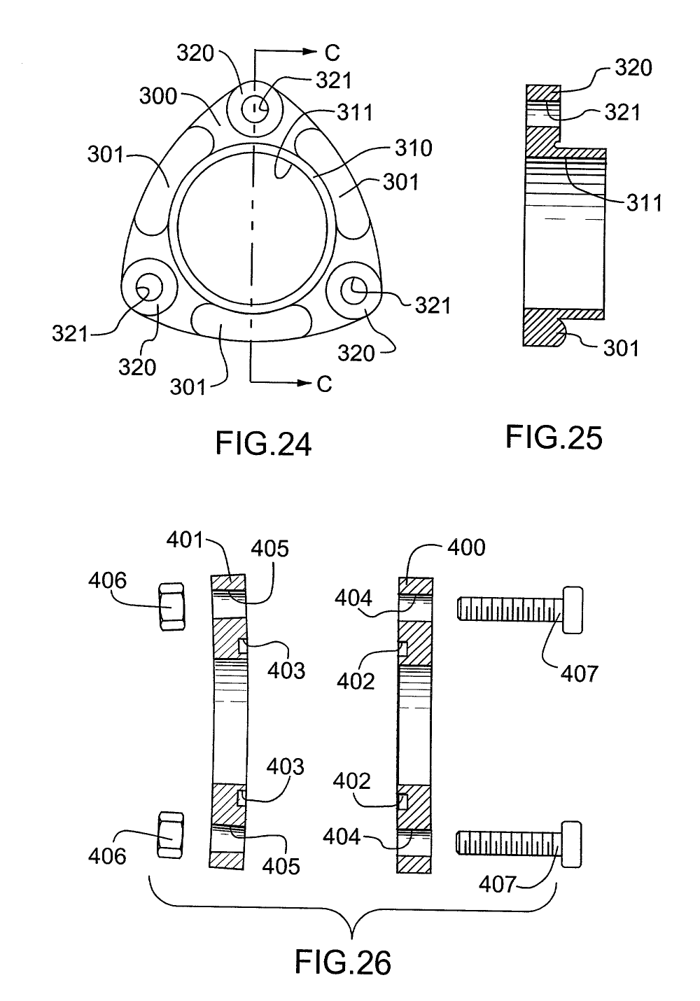

FIGS. 24 and 25 show another embodiment of a flange 300 according to the invention. The flange has raised areas 301 arranged between mounting studs 320 having mounting holes 321. The raised areas provide reinforcement of the flange, to prevent deflection of the flange when tightening the flange to another flange using fastening means (not shown). The flange further has a substantially cylindrical flange extension 310, for attachment of the flange to an exhaust pipe (not shown). The flange extension has an inner diameter 311.

FIG. 26 shows still a further flange pair combination. A straight flange 400, having mounting holes 404 and gasket recesses 402, cooperates with a curved flange 401, having mounting holes 405 and gasket recesses 403. The curved flange is substantially weakly bowl-shaped, the outer edge of the flange bent away from the surface of the curved flange which contacts the straight flange. Thus, when mounting bolts 407 are placed through the mounting holes 404 and 405, respectively, and a mounting nut 406 tightened onto each mounting bolt, the curved flange will deflect towards the flat flange to form a flat sealing surface. This enhances the seal between the two flanges and prevents the further outward deflection of the flange after tightening of the mounting bolts.

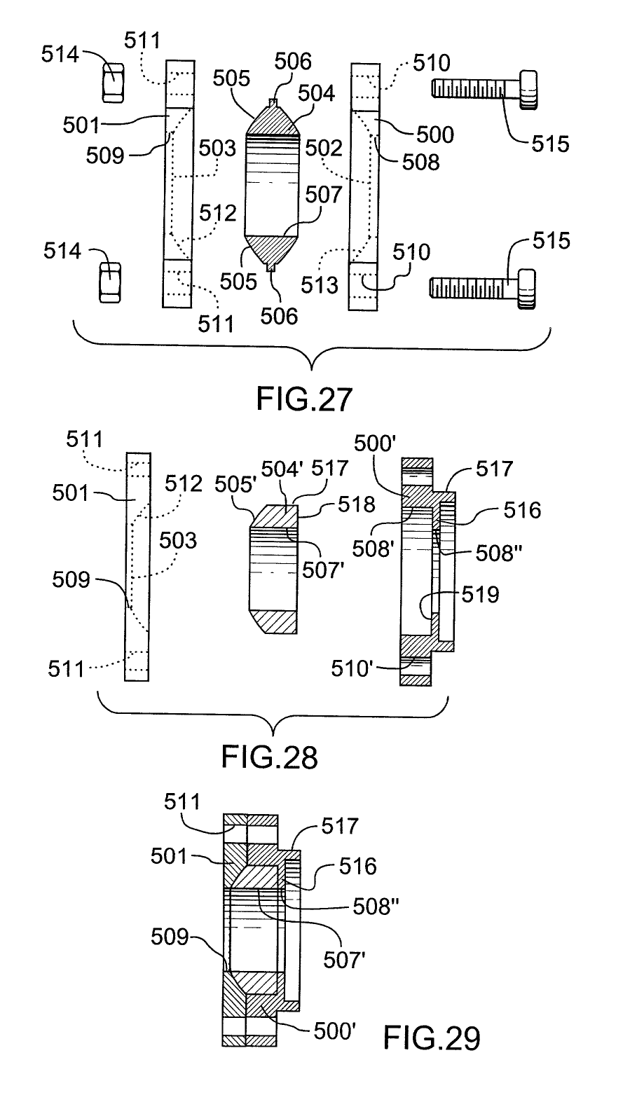

FIG. 27 shows yet a further embodiment of a flange joint, having a gasket element 504 arranged between a fifth flange 500 and a sixth flange 501. The fifth flange has a recess 502, with sloping side walls 513, which generally conforms in shape to a curved surface 505 of the gasket element. The fifth flange further has an inner diameter 508 and mounting holes 510. Similarly, the sixth flange 501 has a recess 503, with curved side walls 512, which generally conforms in shape to the curved surface 505 of the gasket element. The sixth flange further has an inner diameter 509 and mounting holes 511. The gasket element 504 has an inner diameter 507, substantially the same as the inner diameters 508 and 509, respectively, of the flanges. The gasket element further has a flange gap defining protrusion 506 arranged along its circumference. When mounting bolts 515 are inserted into the mounting holes 510 and 511, respectively, and a mounting nut 514 is tightened onto each mounting bolt, the two flanges compress the gasket element 504, which will allow only a limited amount of float (relative movement of the flanges) to provide an enhanced leak resistance for the flange joint.

FIGS. 28 and 29 show a further embodiment of a flange joint, having a composite gasket element 504′ arranged between a sixth flange 501 (as described in conjunction with FIG. 27) and a inner flange 500′. The inner flange has mounting holes 510′ and a substantially cylindrical flange extension 517, for attachment of the flange to an exhaust pipe (not shown). Further, the inner flange 500′ has a backing plate portion 516 arranged on the same side of the flange as the flange extension. The backing plate portion has an inner diameter 508″ and an inner surface 519, facing away from the flange extension side of the flange. The inner flange has a general inner diameter 508′, which is larger than the inner diameter 508″ of the backing plate portion 516. The composite gasket element 504′ has a curved surface 505′, generally conforming in shape to the recess 503, with sloping side walls 512 of the sixth flange. The composite gasket element further has an inner diameter 508′, substantially the same as the inner diameters 508′ and 509, respectively, of the flanges. The gasket element further has an outer surface 517 and a substantially flat surface facing the inner flange 500′. When mounting bolts (not shown) are inserted into the mounting holes 510′ and 511, respectively, and a mounting nut (not shown) is tightened onto each mounting bolt, the two flanges compress the gasket element 504′, which will allow only a limited amount of float (relative movement of the flanges) to provide an enhanced leak resistance for the flange joint. The backing plate portion 516 retains the composite seal between the inner flange 500′ and the composite gasket element 504′.

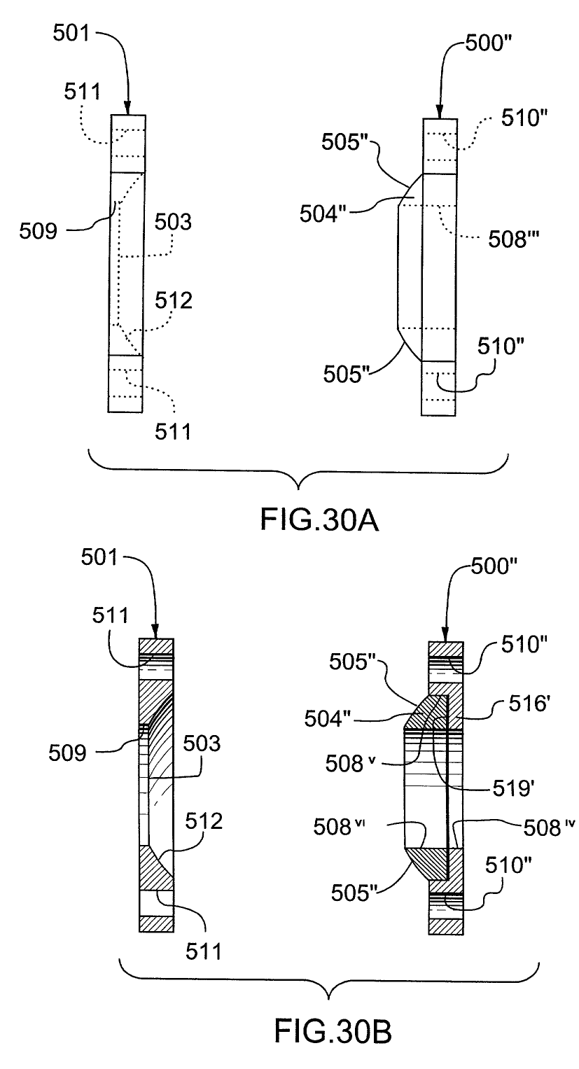

FIGS. 30A and 30B show a further embodiment of a flange joint similar to the embodiment shown in FIGS. 27 to 29, except that a composite gasket element 504″ is bonded to a inner flange 500″, for example by pressing and sintering the two in one sintering step, or sintering the inner flange first then inserting the pressed gasket element and sintering again. The composite gasket element 504″ is thus arranged between a sixth flange 501 (as described in conjunction with FIG. 27) and the inner flange 500″. The inner flange has mounting holes 510″ and a backing plate portion 516′ arranged on the same side of the flange as the flange extension. The backing plate portion has an inner diameter 508^{IV} and an inner surface 519′, facing away from the flange extension side of the flange. The inner flange has a general inner diameter 508^{V}, which is larger than the inner diameter 508^{IV} of the backing plate portion 516′. The composite gasket element 504″ has a curved surface 505″, generally conforming in shape to the recess 503, with sloping side walls 512 of the sixth flange. The composite gasket element further has an inner diameter 508^{VI}, substantially the same as the inner diameters 508^{IV} and 509, respectively, of the flanges.

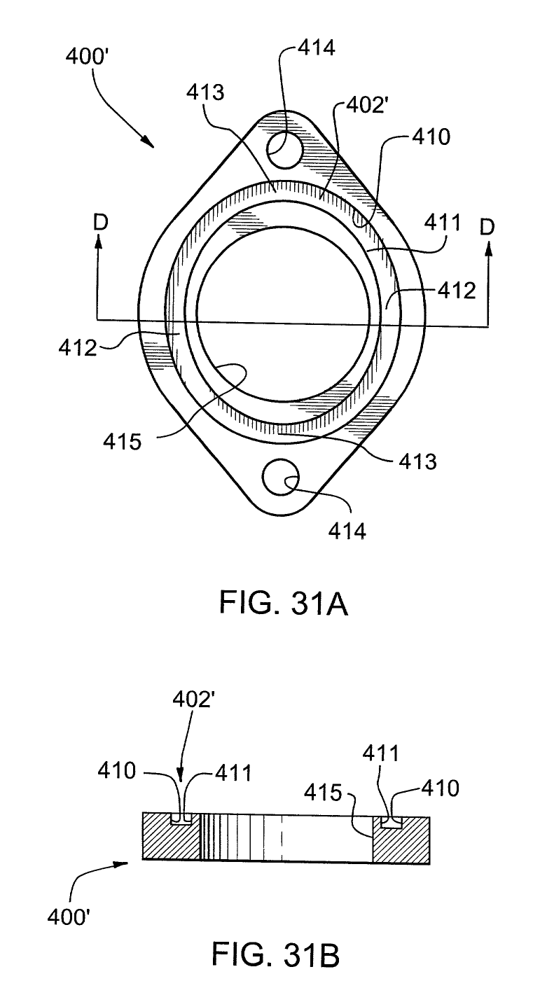

FIGS. 31A and 31B show a preferred embodiment of a flange 400′ having an annular gasket recess 402′, which has an inner wall 411 and an outer wall 410. Further, the flange has mounting holes 414, and an inner diameter 415. The inner wall 411 and the outer wall 410 form at least one squeeze area 412, where the width of the gasket recess, the distance between the outer wall and the inner wall, is substantially narrower than a maximum gasket recess width 411. In this way, the gasket (not shown) will be held in the gasket recess after insertion of the gasket. Preferably, two such squeeze areas 412 are defined in the gasket recess 402′.

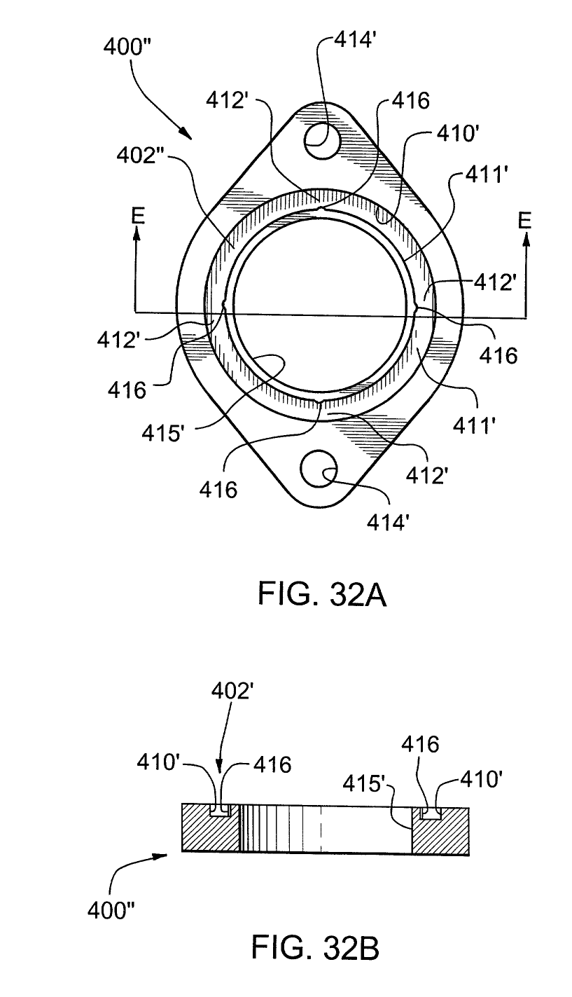

FIGS. 32A and 32B show an alternative preferred embodiment of a flange 400″ having an annular gasket recess 402″, which has an inner wall 411′ and an outer wall 410′. Further, the flange has mounting holes 414′, and an inner diameter 415′. At least one protrusion 416 is arranged along the inner wall 411′ and/or (not shown) the outer wall 410 to form at least one squeeze area 412′, where the width of the gasket recess, the distance between the outer wall and the protrusion, is substantially narrower than a maximum gasket recess width 411′. In this way, the gasket (not shown) will be held in the gasket recess after insertion of the gasket. Preferably, two, three or four such squeeze areas 412′ are defined in the gasket recess 402″, by arranging two, three or four protrusions 416, respectively, on the inner wall 411′.

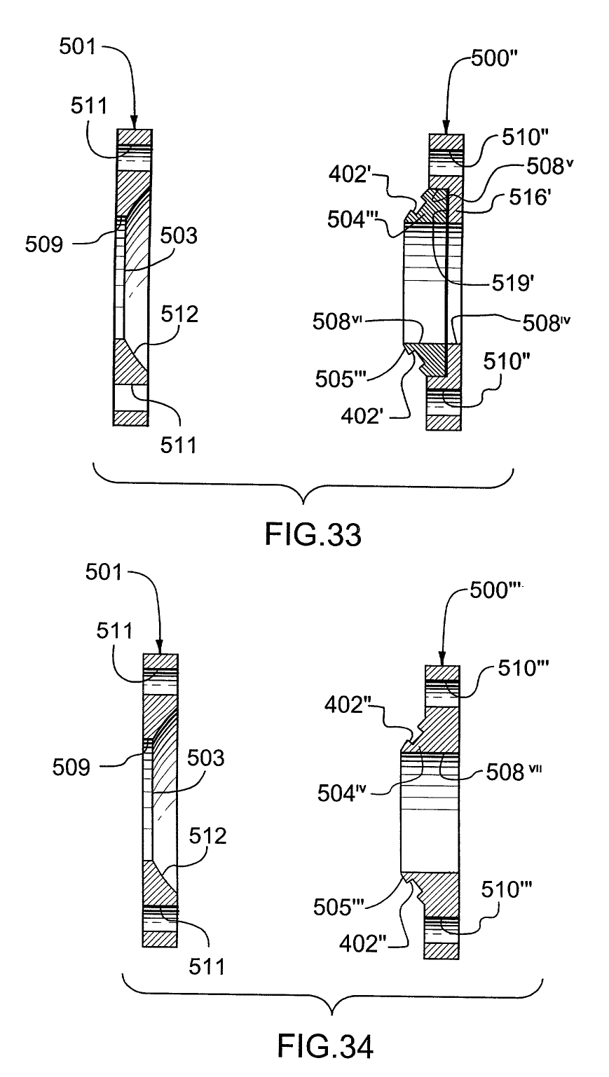

FIG. 33 shows a further embodiment of a flange joint similar to the embodiment shown in FIGS. 30A to 30B. A composite gasket element 504′″ is bonded to a inner flange 500″, for example by pressing and sintering the two in one sintering step, or sintering the inner flange first then inserting the pressed gasket element and sintering again. The composite gasket element 504′″ is thus arranged between a sixth flange 501 (as described in conjunction with FIG. 27) and the inner flange 500″. The inner flange has mounting holes 510″ and a backing plate portion 516′ arranged on the same side of the flange as the flange extension. The backing plate portion has an inner diameter 508^{IV} and an inner surface 519′, facing away from the flange extension side of the flange. The inner flange has a general inner diameter 508^{V}, which is larger than the inner diameter 508^{IV} of the backing plate portion 516′. The composite gasket element 504′″ has a curved surface 505″, generally conforming in shape to the recess 503, with sloping side walls 512 of the sixth flange. The composite gasket element further has an inner diameter 508^{VI}, substantially the same as the inner diameters 508^{IV} and 509, respectively, of the flanges. Additionally, the composite gasket element 504′″ has a gasket recess 402′ arranged on the curved surface 505″, to receive an additional annular sealing gasket (not shown).

FIG. 34 shows still a further embodiment of a flange joint similar to the embodiment shown in FIG. 33. A inner flange 500′″ has an inner diameter 508^{VII}, mounting holes 510′″ and a protrusion 504^{IV}. The protrusion has a curved surface 505′″, which cooperates with a sixth flange 501 (as described in conjunction with FIG. 27) in that it generally conforms in shape to the recess 503, with sloping side walls 512 of the sixth flange. Additionally, the protrusion 504^{IV} has a gasket recess 402″ arranged on the curved surface 505′″, to receive an additional annular sealing gasket (not shown).

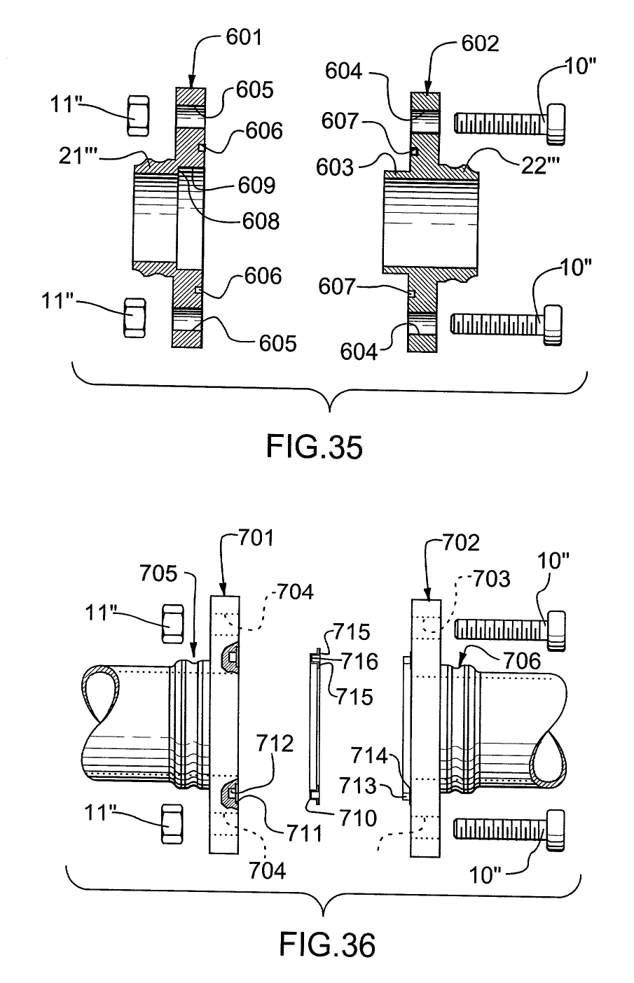

FIG. 35 shows a further embodiment of a flange joint according to the invention, where a inner flange 602 has an exhaust mounting extension 22′″, mounting holes 604, gasket recesses 607 and a sealing extension 603. A outer flange 601 has an exhaust mounting extension 21′″, mounting holes 605, gasket recesses 606 and a sealing recess 608 having an outer diameter substantially corresponding to the outer diameter of the sealing extension 603. The sealing extension and the sealing recess thus cooperate to provide a positive seal and enhanced alignment between the two flanges. The flanges are fastened together using bolts 10″ and nuts 11″.

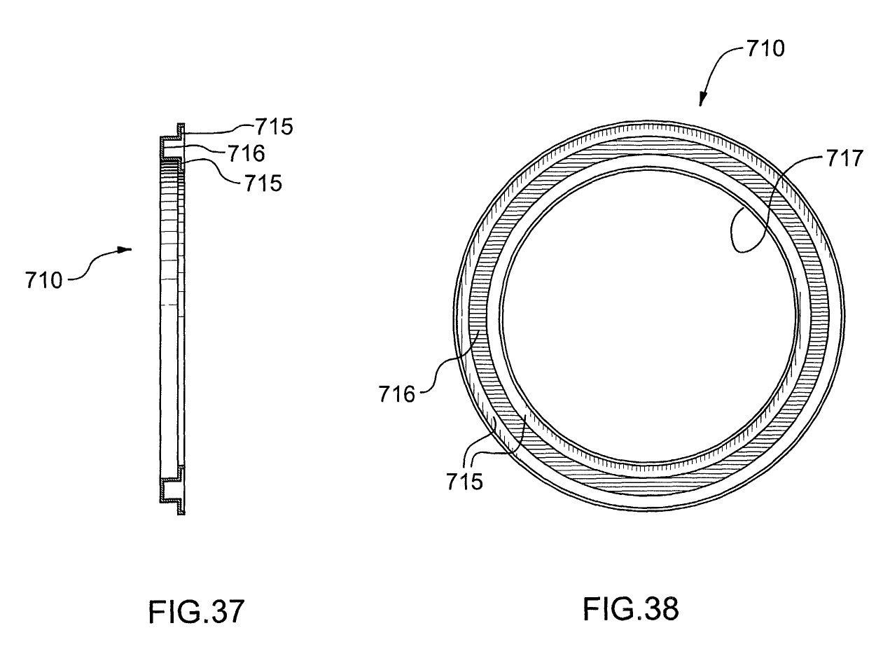

FIGS. 36 to 38 show yet a further embodiment of a flange joint according to the invention, where an “inner” flange 702 has an exhaust mounting extension 706, mounting holes 703 and an annular gasket holding ridge 713 with a base 714. An “outer” flange 701 has an exhaust mounting extension 705, mounting holes 704 and an annular gasket holding recess 712 with an annular ring 711. The gasket holding ridge and the gasket holding recess thus cooperate to positively hold a shaped gasket 710 to provide a positive seal and enhanced alignment between the two flanges. The flanges are fastened together using bolts 10″ and nuts 11″. The gasket is shown in detail in FIGS. 37 and 38, showing the gasket inner diameter 717, which is substantially the same or larger as the inner diameters of the exhaust openings of the flanges. The gasket has five sealing surfaces on its “hat”-like cross-section (brim, side, top, other side and other brim), and this shape gives no direct escape for gases. The gasket is made of a resilient material, and preferably laminated and/or spirally wound.

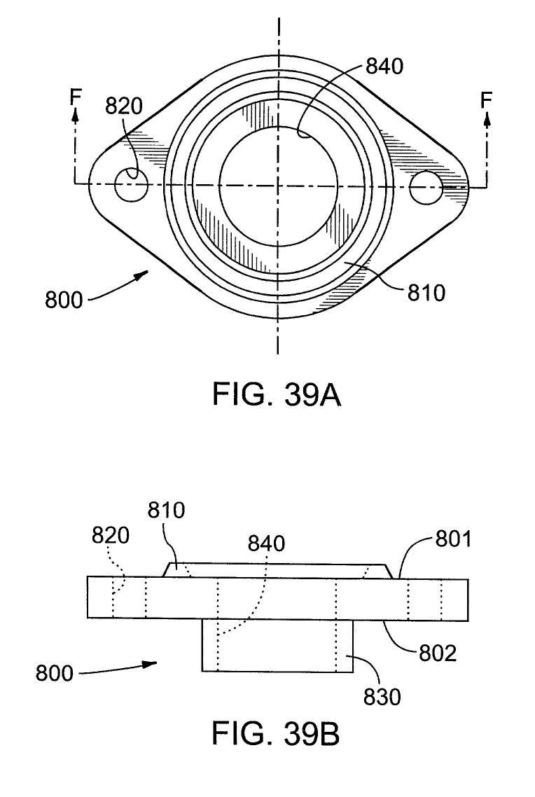

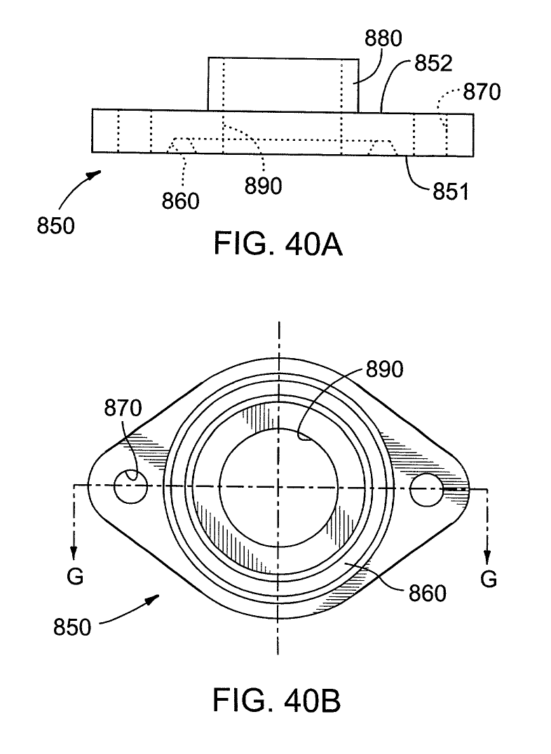

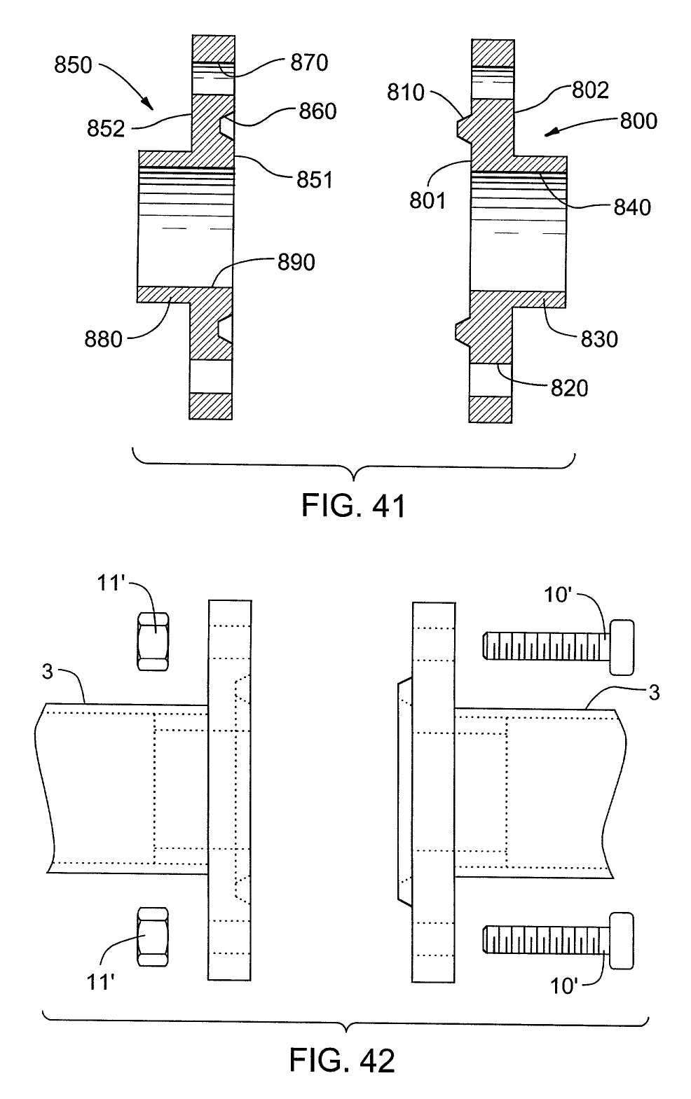

FIGS. 39A to 42 show a further advantageous embodiment of a flange joint according to the invention. FIGS. 39A and 39B show an outer flange 800, having a conical rib 810 on a sealing surface 801 of the outer flange, which cooperates with an inner flange 850 (FIG. 40A). The outer flange further has a pipe attachment surface 802 having a pipe attachment means 830. An exhaust through hole 840 is arranged in the outer flange, for passage of exhaust gas when the flange is assembled as part of an exhaust system flange joint. Mounting holes 820 are also arranged through the outer flange. FIGS. 40A and 40B show the inner flange 850, having a conical recess 860 on a sealing surface 851 of the inner flange. The inner flange further has a pipe attachment surface 852 having a pipe attachment means 880. An exhaust through hole 890 is arranged in the inner flange, for passage of exhaust gas when the flange is assembled as part of an exhaust system flange joint. Mounting holes 870 are also arranged through the outer flange. FIG. 41 shows a flange joint made of the outer flange 800 and the inner flange 850. FIG. 42 shows the flange joint of FIG. 41, with the outer flange 800 and the inner flange 850 joined to respective pipes 3 and connecting bolts 10′ with nuts 11′, used to clamp the flange joint together. When an inner and an outer flange are fastened together, the conical rib 810 and the conical recess 860 form a compression fitting to eliminate leaks in the flange joint. The rigidity of the joint is also enhanced by the compression fitting of the invention.

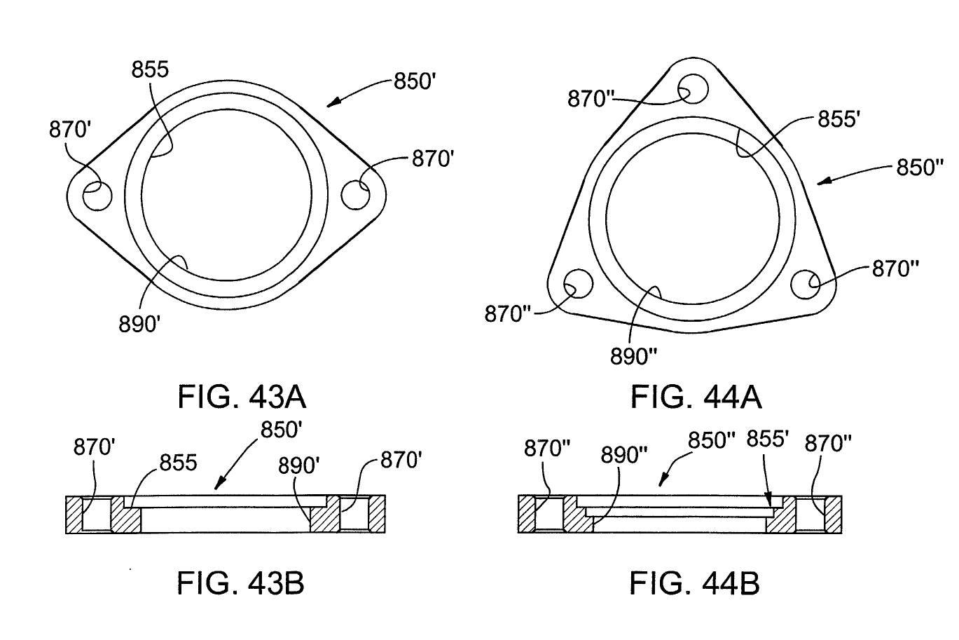

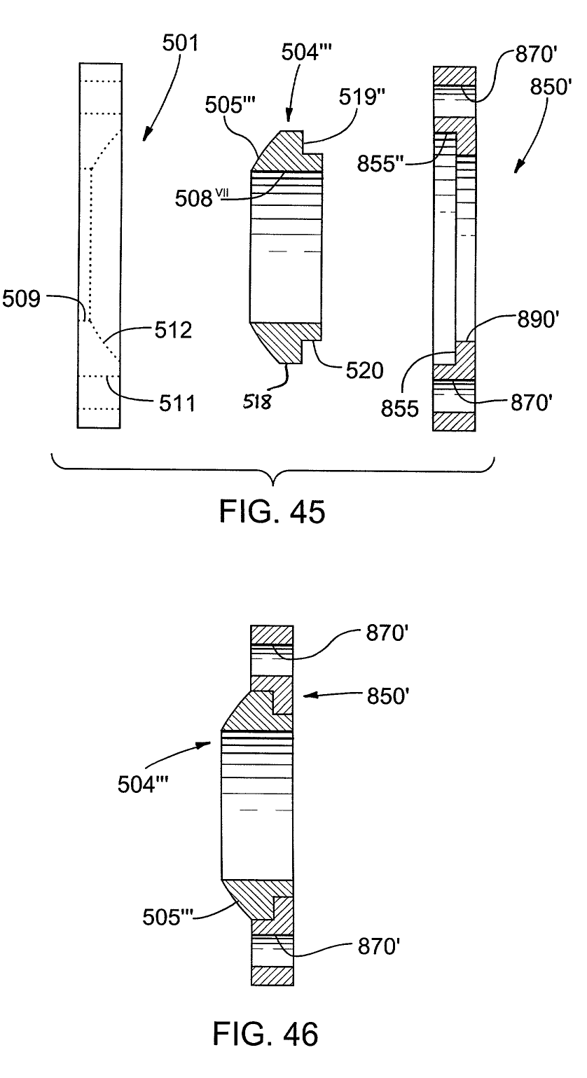

FIGS. 43A to 46 show a further embodiment of a flange joint of the invention. The inner flange 850′, cooperating with an outer flange 501 as described in FIGS. 30A and 30B or an outer flange as described in FIGS. 48A and 48B below, is manufactured in two parts, a flat part (backing plate) which has mounting holes 870′, a central through hole 890′ and a recess 855 with an end wall 855″, and a sealing part 504′″. The flange material is preferably sintered material, possibly different material in the two different parts, for instance using material with enhanced sealing properties for the sealing part and material with enhanced strength for the backing plate. The sealing part has an outwardly curved surface 505′″ generally corresponding to the recess 503, with sloping side walls 512 of the outer flange 501. The sealing part further has a recess 519″ having an inner annular surface 520. The sealing part also has an outer annular sealing surface 518. The sealing part 504′″ further has an inner diameter 508^{VII}, smaller than the inner diameters (central through hole) 890′ and 509, respectively, of the inner flange and the outer flange. The two parts of the inner flange 850′ are made in separate pressing operations of a sintering manufacturing process. The required press force is lower, making it possible to use smaller and cheaper presses. Both parts are optionally pre-sintered at relatively low temperatures and then pressed together and subjected to a final sintering step, during which the two parts bond together. When the two parts are pressed together, the inner flange recess 855 contacts the sealing part recess 519″, and the inner flange recess end wall 855″ contacts the outer annular sealing surface 518, whilst the sealing part inner annular surface 520 contacts the surface of the central through hole 890′, forming mating surfaces for the two parts. Thus, the inner flange recess has a shape cooperating with and corresponding to the shape of the sealing part recess. For the two-piece inner flange described above, a bonding agent/welding flux may be applied to the mating surfaces after an optional pre-sintering step but before final sintering, to enhance the bond between the two parts after sintering. Further, an optional weld may be applied to the inner flange after sintering, to additionally strengthen the joint between the sealing part and the backing plate. The weld would be applied on the side of the inner flange where the sealing part extends from the backing plate, and either be in the form of a tack weld or a continuous weld along the full joint between the sealing part and the backing plate.

As is shown in FIGS. 43A and 43B, the inner flange 850′ may have two mounting holes 870′ and a single step recess 855, as described above. An alternative embodiment of a inner flange 850″ is shown in FIGS. 44A and 44B. The inner flange has three mounting holes 870″ and a multi-stepped recess 855′ corresponding in shape to a multi-stepped recess of the sealing part (not shown). The larger number of mounting holes makes a secure attachment of the inner flange and a outer flange easier, and the multi-stepped recess enlarges the surface area between the two parts of the inner flange, which enhances the bonding between the two parts after final sintering.

As is shown in FIGS. 48A and 48B, also the outer flange 501′ may be of two-piece construction (as inner flange of FIGS. 43A to 46). The outer flange is thus manufactured in two parts, a flat part (backing plate) which has mounting holes 511′, a central through hole 890″ and a recess 855′″ with an end wall 855^{IV}, and a sealing part 504^{IV}. The flange material is preferably sintered material, possibly different material in the two different parts, for instance using material with enhanced sealing properties for the sealing part and material with enhanced strength for the backing plate. The sealing part has an inwardly curved surface 505^{IV}. The sealing part further has a recess 519′″ having an inner annular surface 520′ and an outer annular surface 518′. The sealing part 504^{IV} further has an inner diameter 508^{VIII}, smaller than the central through hole 890″. The two parts of the outer flange 501′ are made in separate pressing operations of a sintering manufacturing process. The required press force is lower, making it possible to use smaller and cheaper presses. Both parts are optionally pre-sintered at relatively low temperatures and then pressed together and subjected to a final sintering step, during which the two parts bond together. When the two parts are pressed together, the outer flange recess 855′″ contacts the sealing part recess 519′″, and the outer flange recess end wall 855^{IV} contacts the outer annular sealing surface 518′, whilst the sealing part inner annular surface 520′ contacts the surface of the central through hole 890″, forming mating surfaces for the two parts. Thus, the outer flange recess has a shape cooperating with and corresponding to the shape of the sealing part recess. For the two-piece outer flange described above, a bonding agent/welding flux may be applied to the mating surfaces after an optional pre-sintering step but before final sintering, to enhance the bond between the two parts after sintering. Further, an optional weld may be applied to the outer flange after sintering, to additionally strengthen the joint between the sealing part and the backing plate. The weld would be applied on the side of the outer flange where the sealing part extends from the backing plate, and either be in the form of a tack weld or a continuous weld along the full joint between the sealing part and the backing plate.

The invention provides a number of advantages, which include that the use of powdered metal permits reduced thickness and weight by permitting the use of reinforcing ribs or the formed lightening holes, that the sealing configuration avoids a direct escape path for exhaust gases, thereby potentially reducing the need for gaskets and potentially reducing emissions and to facilitate the alignment of the different parts of the exhaust system.

Preferably, the outer flange is made of one material and the inner flange is made of another material. In this way, the heat expansion of the flange can be regulated to compensate for differences in heating of the flanges (the flange closest to the engine will theoretically be heated more than the flange further away). By choosing a material having a lower heat expansion for the flange closest to the engine, and a material having a higher heat expansion for the other flange, both flanges can be made to expand equally much during use, thus enhancing the fit and seal of the flange assembly.

Preferably, the materials used for making the flanges contain between 0.75 to 1 weight percent of hexagonal boron nitride (BN), which enhances the corrosion resistance properties of the powder metallurgical materials used, as disclosed in U.S. Pat. No. 6,103,185.

Using flanges as described in the different embodiments of the invention will enhance the sealing and rigidity properties of the flange joint, compared to known flange assemblies.

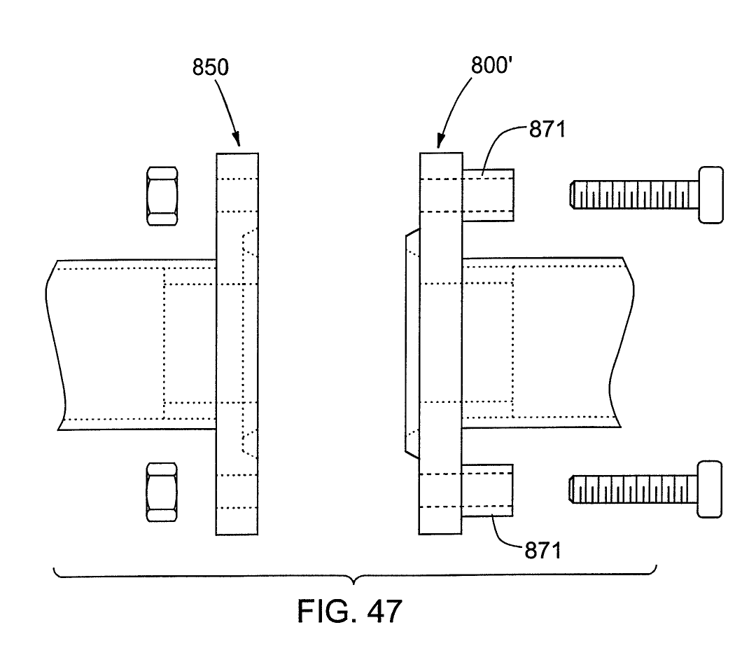

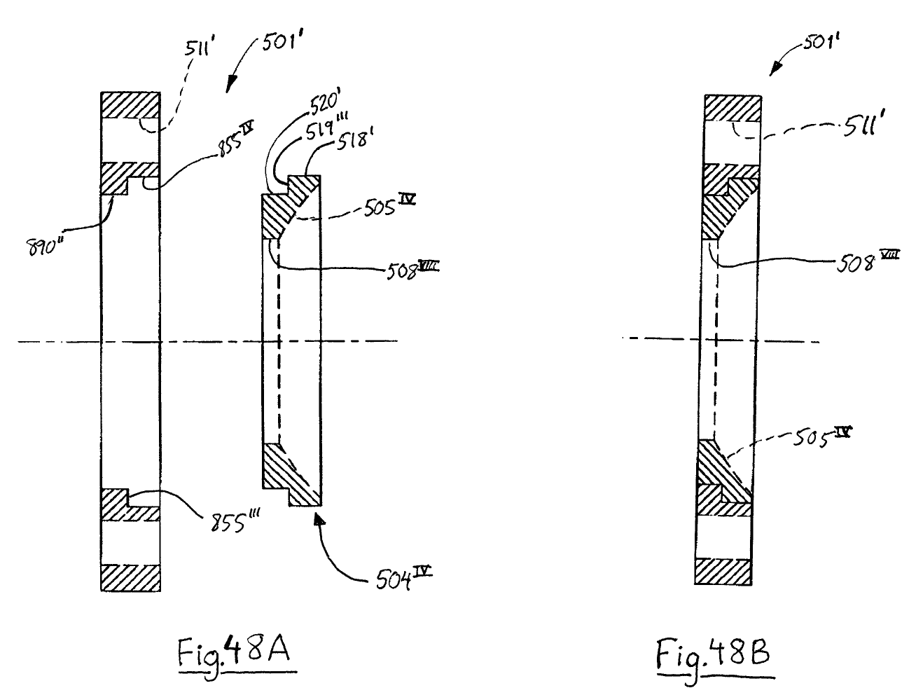

It will be appreciated that the above description relates to the preferred embodiment by way of example only. Many variations on the invention will be obvious to those knowledgeable in the field, and such obvious variations are within the scope of the invention as described and claimed, whether or not expressly described. For example, when assembling exhaust pipes it might be economical to use standard length bolts, which might be too long for the application and possibly interfere with the pipe if it has a sharp bend adjacent the flange. To accommodate longer bolts, it is foreseen to produce the sintered flanges having a stand-off sleeve integrally formed on the surface of the flange which faces away from the sealing surface of the flange, as shown in FIG. 47. When using a two-piece flange, having a separate sealing part, the two parts may be fixed to each-other by low-strength glue, or similar, to secure the sealing part in place until the flange is used with another flange to form a flange assembly. After the flanges are joined, the sealing part will be held in place by the joining forces.

1. An exhaust flange assembly for attaching exhaust pipes, said assembly comprising:
an outer flange, having a sealing surface and a pipe attachment means arranged on a pipe attachment surface opposite to said sealing surface; and
an inner flange, having a sealing surface and a pipe attachment means arranged on a pipe attachment surface opposite to said sealing surface, where said outer flange and said inner flange are made of powder metallurgically produced material and said sealing surface of said outer flange has a cavity and said sealing surface of said inner flange is shaped to be closely received by said cavity when said outer flange and said inner flange are assembled.

2. The exhaust flange assembly as recited in claim 1, wherein said outer flange is made of one material and said inner flange is made of a different material.

3. The exhaust flange assembly as recited in claim 1, wherein at least one of said flanges has an annular gasket recess arranged on said sealing surface of said flange.

4. The exhaust flange assembly as recited in claim 3, wherein said annular gasket recess has gasket retaining means.

5. The exhaust flange assembly as recited in claim 4, wherein said gasket retaining means comprise gasket recess protrusions.

6. The exhaust flange assembly as recited in claim 4, wherein said gasket retaining means comprise said gasket recess being generally oval.

7. The exhaust flange assembly as recited in claim 1, wherein said pipe attachment surfaces of said flanges have one or more reinforcement ribs.

8. The exhaust flange assembly as recited in claim 1, wherein said flanges have at least one hole therethrough for weight reduction.

9. The exhaust flange assembly as recited in claim 1, wherein said outer flange and said inner flange have bolt mounting holes arranged to receive threaded bolts onto which nuts are threadable, whereby said flanges may be pulled together for a secure connection by tightening said nuts.

10. The exhaust flange assembly as recited in claim 9, wherein said bolts have generally spherical portions facing the bolt thread, said spherical portions of said bolts arranged to cooperate with generally concave recesses arranged in said flanges around said mounting holes.

11. The exhaust flange assembly as recited in claim 1, wherein said outer flange has a curved extension protruding in a direction opposite to said cavity, and said inner flange has a curved extension protruding in a direction opposite to said sealing surface of said inner flange, said extensions arranged to be fitted into said ends of exhaust pipes, thereby deforming said exhaust pipes to form a joint.

12. The exhaust flange assembly as recited in claim 11, wherein said extensions have a groove surrounded by an inner ridge and an outer ridge, arranged on an outer surface of said extension.

13. The exhaust flange assembly as recited in claim 11, wherein at least one of said flanges has an annular gasket recess arranged on said sealing surface of said flange.

14. The exhaust flange assembly as recited in claim 11, wherein said pipe attachment surfaces of said flanges have a plurality of reinforcement ribs.

15. The exhaust flange assembly as recited in claim 11, wherein said flanges have at least one hole therethrough for weight reduction.

16. The exhaust flange assembly as recited in claim 1, wherein said inner flange comprises a first substantially flat part and a second annular sealing part, said first part having a first recess and said second part having a second recess and where said first recess and said second recess have complimentary shapes so that said first recess fits in said second recess.

17. The exhaust flange assembly as recited in claim 16, wherein said first recess and said second recess have multiple steps.

18. The exhaust flange assembly as recited in claim 1, wherein one of said flanges has integral mounting studs extending from said sealing surface of said flange, said studs configured to extend through corresponding holes in the other said flange, said studs being threaded to receive nuts whereby said flanges may be pulled together for a secure connection by tightening said nuts.

19. The exhaust flange assembly as recited in claim 1, wherein one of said outer flange and said inner flange is generally straight and the other flange is generally curved, where an outer edge of said curved flange is bent away from a surface of said curved flange which contacts said straight flange, so that, when said straight flange is mounted to said curved flange by fasteners, said curved flange deflects towards said flat flange to form a flat sealing surface, thus enhancing the seal between said curved flange and said straight flange.

20. The exhaust flange assembly as recited in claim 19, wherein said straight flange and said curved flange have mounting holes and said fasteners comprise mounting bolts, for placing through said mounting holes, and mounting nuts to be tightened onto each said mounting bolt, for fastening said straight flange to said curved flange.

21. The exhaust flange assembly as recited in claim 19, wherein said straight flange and said curved flange have gasket recesses, for accommodating gaskets.

22. The exhaust flange assembly as recited in claim 19, wherein said curved flange is substantially weakly bowl-shaped.

23. The exhaust flange assembly as recited in claim 1, wherein said inner flange comprises a recess having a gasket element shaped to be closely received in said recess on one side of said gasket element and to be closely received by said cavity of said outer flange on another side of said gasket element.

24. An elongated substantially flat exhaust flange comprising a sealing surface and a pipe attachment means arranged on a pipe attachment surface opposite to said sealing surface, said sealing surface having a cavity, and where at least a part of said flange is made of powder metallurgically produced material.

25. The exhaust flange as recited in claim 24, wherein said flange comprises a first substantially flat part and a second annular sealing part, said first part having a first recess and said second part having a second recess and where said first recess and said second recess have complimentary shapes so that said first recess fits in said second recess.

26. The exhaust flange as recited in claim 25, wherein said second part is made of powder metallurgically produced material.

27. The exhaust flange as recited in claim 25, wherein said first part is made of powder metallurgically produced material.

28. The exhaust flange as recited in claim 25, wherein said first part and said second part are made of powder metallurgically produced material.

29. The exhaust flange as recited in claim 25, wherein said flange has an annular gasket recess arranged on said sealing surface of said flange.

30. The exhaust flange as recited in claim 29, wherein said annular gasket recess has gasket retaining means.

31. The exhaust flange as recited in claim 30, wherein said gasket retaining means comprise gasket recess protrusions.

32. The exhaust flange as recited in claim 30, wherein said gasket retaining means comprise said gasket recess being generally oval.

33. The exhaust flange as recited in claim 25, wherein said pipe attachment surface of said flange have one or more reinforcement ribs.

34. The exhaust flange as recited in claim 25, wherein said flange has at least one hole therethrough for weight reduction.

35. The exhaust flange as recited in claim 25, wherein said flange has bolt mounting holes arranged to receive threaded bolts onto which nuts are threadable.

36. The exhaust flange as recited in claim 35, wherein said bolts have generally spherical portions facing the bolt thread, said spherical portions of said bolts arranged to cooperate with generally concave recesses arranged in said flange around said mounting holes.

37. The exhaust flange as recited in claim 25, wherein said flange has a curved extension protruding in a direction opposite to said cavity, said extension arranged to be fitted into said end of said exhaust pipe, thereby deforming said exhaust pipe to form a joint.

38. The exhaust flange as recited in claim 37, wherein said extension has a groove surrounded by an inner ridge and an outer ridge, arranged on an outer surface of said extension.

39. An elongated substantially flat exhaust flange comprising a sealing surface and a pipe attachment means arranged on a pipe attachment surface opposite to said sealing surface, said sealing surface having a protrusion, and where at least a part of said flange is made of powder metallurgically produced material.

40. The exhaust flange as recited in claim 39, wherein said flange comprises a first substantially flat part and a second annular sealing part, said first part having a first recess and said second part having a second recess and where said first recess and said second recess have complimentary shapes so that said first recess fits in said second recess.

41. The exhaust flange as recited in claim 40, wherein said second part is made of powder metallurgically produced material.

42. The exhaust flange as recited in claim 40, wherein said first part is made of powder metallurgically produced material.

43. The exhaust flange as recited in claim 40, wherein said first part and said second part are made of powder metallurgically produced material.

44. The exhaust flange as recited in claim 40, wherein said flange has an annular gasket recess arranged on said sealing surface of said flange.

45. The exhaust flange as recited in claim 44, wherein said annular gasket recess has gasket retaining means.

46. The exhaust flange as recited in claim 45, wherein said gasket retaining means comprise gasket recess protrusions.

47. The exhaust flange as recited in claim 45, wherein said gasket retaining means comprise said gasket recess being generally oval.

48. The exhaust flange as recited in claim 40, wherein said pipe attachment surface of said flange have one or more reinforcement ribs.

49. The exhaust flange as recited in claim 40, wherein said flange has at least one hole therethrough for weight reduction.

50. The exhaust flange as recited in claim 40, wherein said flange has bolt mounting holes arranged to receive threaded bolts onto which nuts are threadable.

51. The exhaust flange as recited in claim 50, wherein said bolts have generally spherical portions facing the bolt thread, said spherical portions of said bolts arranged to cooperate with generally concave recesses arranged in said flange around said mounting holes.

52. The exhaust flange as recited in claim 40, wherein said flange has a curved extension protruding in a direction opposite to said cavity, said extension arranged to be fitted into said end of said exhaust pipe, thereby deforming said exhaust pipe to form a joint.

53. The exhaust flange as recited in claim 52, wherein said extension has a groove surrounded by an inner ridge and an outer ridge, arranged on an outer surface of said extension.

54. The exhaust flange assembly as recited in claim 1, wherein the sintered materials used for making the flanges contain between 0.75 to 1 weight percent of hexagonal boron nitride for enhanced corrosion resistance.

55. A method of producing exhaust flanges, comprising the steps of:
a) press-forming metal powder to shape a first substantially flat part of a flange;
b) press-forming metal powder to shape a second annular sealing part of said flange;
c) fitting said first part onto said second part; and
d) sintering said first part and said second part to thereby bond them together and form said flange.

56. The method of producing exhaust flanges as recited in claim 55, wherein said method comprises the step of pre-sintering said first part and said second part after press-forming but before fitting said first part onto said second part.

57. The method of producing exhaust flanges as recited in claim 56, wherein a weld is applied to a joint between said first part and said second part.

58. A method of producing exhaust flanges, comprising the steps of:
a) stamping metal to shape a first part of a flange;
b) press-forming metal powder to shape a second annular sealing part of said flange;
c) sintering said sealing part;
d) fitting said first part onto said second part; and
e) joining said first part and said second part to thereby bond them together and form said flange.

59. The method of producing exhaust flanges as recited in claim 58, wherein said joining step comprises welding said first part to said second part.

60. The method of producing exhaust flanges as recited in claim 58, wherein said joining step comprises brazing said first part to said second part.

61. The method of producing exhaust flanges as recited in claim 58, wherein said joining step comprises glueing said first part to said second part.
